(19) United States
(12) Patent Application Publication
(10) Pub. No.: US 2025/0045289 A1
(43) Pub. Date: Feb. 6, 2025

(54) PRESENTATION CONTROL METHOD, CONTROL DEVICE, PRESENTATION DEVICE, AND READABLE STORAGE MEDIUM

(71) Applicant: BOE Technology Group Co., Ltd., Beijing (CN)

(72) Inventors: Danfeng ZHU, Beijing (CN); Quanzhong WANG, Beijing (CN); Zhe ZHANG, Beijing (CN); Dong HONG, Beijing (CN)

(21) Appl. No.: 18/579,336

(22) PCT Filed: Sep. 19, 2022
(86) PCT No.: PCT/CN2022/119539

§ 371 Date: Jan. 13, 2024

(51) Int. Cl. G06F 16/25

(52) U.S. Cl. CPC G06F 16/254

(57) ABSTRACT

A presentation control method, a control device, a presentation device, and a computer-readable storage medium are provided. The method includes: acquiring a program information; the program information at least includes: identification information of presentation devices, and operating content information of each presentation device; generating a mapping relation file according to the program information; the mapping relation file includes control instructions and control information corresponding to each control instruction, which corresponds to one control period; each control instruction at least carries identification information of a target presentation device, and the control information includes operating content information of the target presentation device in a control period; and the target presentation device is a presentation device operating in the control period; and sending a control instruction to the target presentation device in the control period the target presentation device acquires the corresponding operating content information from the mapping relation file for presentation.

### TECHNICAL FIELD

The present disclosure relates to the field of display technology, in particular to a presentation control method, a control device, a presentation device, and a computer-readable storage medium.

### BACKGROUND

In a large-scale stage performance scene, a great number of presentation devices (such as display devices, audio devices and lighting devices) are required to cooperate with each other to complete a performance. Control circuits for these devices are extremely complicated and there are differences in models even for the same type of presentation devices. In addition, it is necessary for operational staffs at a performance site to synchronously control the performance through wireless communication devices. In order to ensure the presentation effect of stage programs, it is necessary in the control process to reserve a delay time of each part and a corresponding emergency processing time for the programs. Such the performance mode puts forward high requirements for the operational staffs, the presentation devices and the field communication environment, has extremely low fault-tolerant rate and cannot ensure the stage effect of the programs.

### SUMMARY

The embodiment of the present disclosure provides a presentation control method, a control device, a presentation device, and a computer-readable storage medium.

In a first aspect, an embodiment of the present disclosure provides a presentation control method applied to a control device in a presentation system, the presentation system further including a plurality of presentation devices, wherein the method includes: acquiring a program information, wherein the program information at least includes: identification information of the plurality of presentation devices, and operating content information of each presentation device; generating a mapping relation file according to the program information; wherein the mapping relation file includes a plurality of control instructions with frequencies and control information corresponding to each control instruction, and each control instruction corresponds to one control period; each control instruction at least carries identification information of a target presentation device, and the control information at least includes operating content information of the target presentation device in a control period; and the target presentation device is a presentation device operating in the control period; and sending a control instruction to the target presentation device in the control period, so that the target presentation device acquires the corresponding operating content information from the mapping relation file for presentation.

In some embodiments, generating the mapping relation file according to the program information includes: storing the operating content information of each presentation device in each control period in a multi-layer storage structure according to device attribute of each presentation device to obtain the mapping relation file; wherein the operating content information of each presentation device in each control period, and the control instruction corresponding to the operating content information of each presentation device in each control period are stored in a storage structure in a lowest layer of the multi-layer storage structure.

In some embodiments, each of the remaining layers of the multi-layer storage structure, except for a top layer, includes a plurality of storage structures, and in any two adjacent layers, one storage structure in a previous layer is linked to a plurality of storage structures in a next layer.

In some embodiments, the number of storage structures in a lowest layer is multiple, each storage structure corresponds to one presentation device, and each storage structure stores therein: the operating content information of the presentation device in respective control periods and the corresponding control instructions.

In some embodiments, generating the mapping relation file according to the program information includes: storing the operating content information of each presentation device in each control period in a multi-layer storage structure according to a plurality of control periods to obtain the mapping relation file; wherein the operating content information of each presentation device in each control period, and the control instruction corresponding to the operating content information of each presentation device in each control period are stored in a storage structure in a lowest layer of the multi-layer storage structure.

In some embodiments, each of the remaining layers of the multi-layer storage structure, except for a top layer, includes a plurality of storage structures, and in any two adjacent layers, there is a link between one storage structure in a previous layer and a plurality of storage structures in a next layer.

In some embodiments, the number of storage structures in a lowest layer is multiple, each storage structure corresponds to one control period, and each storage structure stores therein: the operating content information of respective presentation devices operating in the control period and a corresponding control instructions.

In some embodiments, sending the control instruction to the target presentation device in the control period includes: sending the control instruction to all the presentation devices at an initial time of the control period so that each presentation device verifies the control instruction, and after the verification is passed, determining the presentation device is the target presentation device.

In some embodiments, the identification information includes a MAC address of the presentation device.

In some embodiments, device types of the plurality of presentation devices include: at least two of a display device, an audio device, a lighting device.

In some embodiments, the control period is less than 1 second.

In a second aspect, an embodiment of the present disclosure provides a presentation control method applied to a presentation device in a presentation system, the method including: acquiring a control instruction sent by a control device, and performing a verification according to identification information carried in the control instruction; and in response to the verification being passed, determining that the presentation device is a target presentation device; and accessing, by the target presentation device, a mapping relation file generated in advance, extracting corresponding operating content information and operating according to the operating content information.

In some embodiments, acquiring the control instruction sent by the control device, and performing the verification according to the identification information carried in the control instruction includes: the verification is passed in response to the identification information of the presentation device being consistent with the identification information carried in the control instruction.

In some embodiments, the mapping relation file includes a multi-layer storage structure; in the lowest layer, the number of the storage structures is multiple, each storage structure corresponds to one presentation device, and each storage structure stores therein: the operating content information of the presentation device in respective control periods and the corresponding control instructions; accessing, by the target presentation device, the mapping relation file generated in advance, extracting the corresponding operating content information includes: determining, by the target presentation device, a target storage structure in the multiple storage structures according to the identification information; and extracting, by the target presentation device, the operating content information corresponding to the frequency from the target storage structure according to the frequency of the control instruction.

In some embodiments, the mapping relation file includes a multi-layer storage structure; in the lowest layer, the number of the storage structures is multiple, each storage structure corresponds to one control period, and each storage structure stores therein: the operating content information of respective presentation devices operating in the control period and the corresponding control instructions; accessing, by the target presentation device, the mapping relation file generated in advance, extracting the corresponding operating content information includes: determining, by the target presentation device, a target storage structure of the multiple storage structures according to the control period; and extracting, by the target presentation device, the operating content information corresponding to the frequency and the identification information from the target storage structure according to the frequency of the control instruction and the identification information.

In a third aspect, an embodiment of the present disclosure provides a control device, including: an acquisition module configured to acquire a program information, wherein the program information at least includes: identification information of the plurality of presentation devices, and operating content information of each presentation device; a generation module configured to generate a mapping relation file according to the program information; wherein the mapping relation file includes a plurality of control instructions with frequencies and control information corresponding to each control instruction, and each control instruction corresponds to one control period; each control instruction at least carries identification information of a target presentation device, and the control information at least includes operating content information of the target presentation device in a control period; and the target presentation device is a presentation device operating in the control period; and a sending module configured to send a control instruction to the target presentation device in the control period, so that the target presentation device acquires the corresponding operating content information from the mapping relation file for presentation.

In a fourth aspect, an embodiment of the present disclosure provides a presentation device, including: a verification module configured to acquire a control instruction sent by a control device, and perform a verification according to identification information carried in the control instruction; and determine that the presentation device is a target presentation device in response to the verification being passed; and an extraction module configured to access, by the target presentation device, a mapping relation file generated in advance, extract corresponding operating content information for presentation.

In a fifth aspect, an embodiment of the present disclosure provides a control device, including a memory and a processor, where the memory stores a computer program, and the computer program, when executed by the processor, implements the methods of the first and second aspects.

In a sixth aspect, an embodiment of the present disclosure provides a computer-readable storage medium, on which a computer program is stored, wherein the computer program, when executed by a processor, implements the method of the first and second aspects.

### BRIEF DESCRIPTION OF DRAWINGS

The accompanying drawings, which are provided for further understanding of the present disclosure and constitute a part of this specification, are for explaining the present disclosure together with the embodiments of the present disclosure, but are not intended to limit the present disclosure. In the drawings:

FIG. 1 is a schematic flowchart of a presentation control method according to an embodiment of the present disclosure.

FIG. 2 is another schematic flowchart of a presentation control method according to an embodiment of the present disclosure.

FIG. 3 is another schematic flowchart of a presentation control method according to an embodiment of the present disclosure.

FIG. 4 is another schematic flowchart of a presentation control method according to an embodiment of the present disclosure.

FIG. 5 is a schematic diagram of a structure of a control device according to an embodiment of the present disclosure.

FIG. 6 is a schematic diagram of a structure of a presentation device according to an embodiment of the present disclosure.

FIG. 7 is a schematic diagram of another structure of a control device according to an embodiment of the present disclosure.

FIG. 8 is a schematic diagram of a computer-readable storage medium according to some embodiments of the present disclosure.

### DETAIL DESCRIPTION OF EMBODIMENTS

The detail description of embodiments of the present disclosure will be described in further detail with reference to the accompanying drawings. It should be understood that the detail description of embodiments described here is only used to illustrate and explain the present disclosure, but not limit the present disclosure.

To make the objects, technical solutions and advantages of the embodiments of the present disclosure more apparent, the technical solutions of the embodiments of the present disclosure will be clearly and completely described below with reference to the drawings of the embodiments of the present disclosure. It is to be understood that the described embodiments are only a few, not all of, embodiments of the present disclosure. All other embodiments, which can be derived by a person skilled in the art from the embodiments of the present disclosure without any creative effort, are within the protective scope of the present disclosure.

Unless defined otherwise, technical or scientific terms used herein shall have the ordinary meaning as understood by one of ordinary skill in the art to which the present disclosure belongs. The terms “first”, “second”, and the like used in the present disclosure are not intended to indicate any order, quantity, or importance, but rather are used for distinguishing one element from another. The term of “comprising”, “including”, or the like, means that the element or item preceding the term contains the element or item listed after the term and its equivalent, but does not exclude other elements or items. The term “connected”, “coupled”, or the like is not limited to physical or mechanical connections, but may include electrical connections, whether direct or indirect connections. The terms “upper”, “lower”, “left”, “right”, and the like are used only for indicating relative positional relationships, and when the absolute position of an object being described is changed, the relative positional relationships may also be changed accordingly.

In a large-scale stage performance scene, a great number of presentation devices (such as display devices, audio devices and lighting devices) are required to cooperate with each other to complete a performance. Control circuits for these devices are extremely complicated and there are differences in models even for the same type of presentation devices. Therefore, it is very difficult to synchronously control a plurality of presentation devices.

In the related art, the plurality of presentation devices have different hardware, different brands, different models, different signal transmission lines, and the like, so that data/information transmission delay between the presentation devices may be caused, and the delayed data is stored in a buffer area. When the amount of the data/information in the buffer area is great, a data sticky phenomenon may occur, and the program effect presented by the presentation devices may be delayed backwards due to the data sticky phenomenon. In addition, it is necessary for operational staffs at a performance site to synchronously control the presentation devices through wireless communication devices.

Therefore, in order to ensure the presentation effect of programs, on one hand, the instantaneity between the communication devices of the operational staffs needs to be ensured, and on the other hand, the delay of signaling interaction among the plurality of presentation devices needs to be avoided. Such the performance mode puts forward high requirements for the operational staffs, the presentation devices and the field communication environment, has extremely low fault-tolerant rate and cannot ensure the stage effect of the programs.

In order to solve at least one of the above technical problems, embodiments of the present disclosure provide a presentation control method, which avoids interference and signaling delay between presentation devices, thereby ensuring a presentation effect.

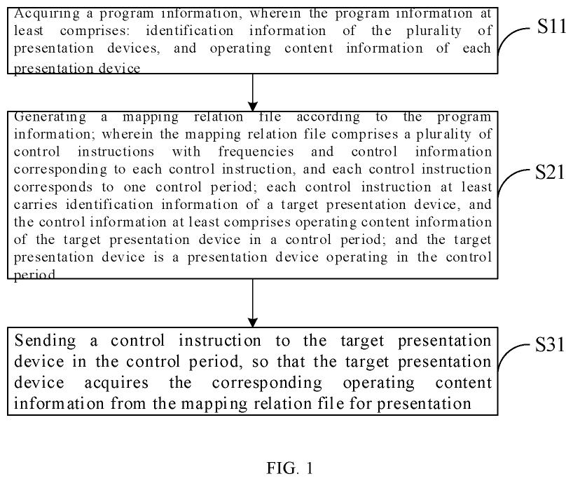

FIG. 1 is a schematic flowchart of a presentation control method according to an embodiment of the present disclosure. As shown in FIG. 1, a presentation system includes a plurality of presentation devices, and the method includes steps S11 to S31.

In step S11, a program information is acquired, where the program information at least includes: identification information of the plurality of presentation devices, operating content information of each presentation device.

It should be noted that the program information is pre-programmed by the operational staffs according to the scene requirements and is related to the presentation program and the corresponding presentation device. In one example, the program information includes a dance program, and thus, a device for presenting the dance program may include A lighting devices, B display devices, and C audio devices. The A lighting devices are controlled by a relay to light up at a preset frequency and/or a preset color in a first preset time period; the B display devices display preset pictures in a second preset time period; and the C audio devices synchronously or asynchronously play preset audio. Meanwhile, in order to ensure the synchronization of the sound, the light and the pictures, different types of presentation devices need to synchronously present the respective corresponding operating content information. For example, at the moment that a bi display device displays a first picture, the A lighting devices start to flash. Therefore, the program information includes two kinds of information, the first kind of information includes the program content information required to be presented at each moment in the timing aspect; the second kind of information includes the operating content information required to be presented by each presentation device in the corresponding time period in the device aspect. In addition, the matching between the presentation device and its corresponding operating content information is embodied by identification information, which is a unique identification code for verifying the presentation device.

In step S21, a mapping relation file is generated according to the program information; where the mapping relation file includes a plurality of control instructions with frequencies and control information corresponding to each control instruction, and each control instruction corresponds to one control period; each control instruction at least carries identification information of a target presentation device, and the control information at least includes operating content information of the target presentation device in a control period; the target presentation device is a presentation device operating in the control period.

Optionally, each control instruction is configured with a corresponding frequency and a control period. That is, in a specific implementation, a control device sends the control instruction at a certain time (e.g. an initial time) in the control period with the frequency. It should be noted that each control instruction corresponds to one control period, and the same control period may correspond to one or more control instructions. That is, one or more control instructions may be sent as needed in one control period. The frequency occupied by the control instruction (i.e., the frequency of the control instruction) is pre-allocated and different control instructions occupy (have) different frequencies, so that no interference exist among a plurality of control instructions even if the plurality of control instructions are sent at the same time.

The process of generating the mapping relation file is explained in detailed in the following embodiments, and is not described here.

In step S31, a control instruction is sent to the target presentation device in the control period, so that the target presentation device acquires the corresponding operating content information from the mapping relation file for presentation.

In the presentation control method provided by the embodiment of the present disclosure, the control period, the control instruction with the frequency, and the control information are associated with each other, and the control instruction carries identification information corresponding to each target presentation device, and the control information includes the operating content information of the target presentation device in the control period. Compared with the prior art, in the present disclosure, the control instruction occupying a certain frequency is sent in the control period, so that the phenomenon of interference among the signaling or signaling delay can be avoided; and the mapping relation file is established, so that the target presentation device acquires the corresponding operating content information in the mapping relation file without sending the operating content information to the target presentation device, so that the problems of delay caused by congestion of a communication link between the presentation devices and the data sticky phenomenon caused by different models of a transmitting device and a receiving device are solved; in addition, the identification information is used as the unique identification of the presentation device, so that the problem that the operating content information is not matched with the presentation device is solved, the accurate control over each presentation device and each presentation program in the large-scale stage performance is achieved, and the program presentation effect is improved.

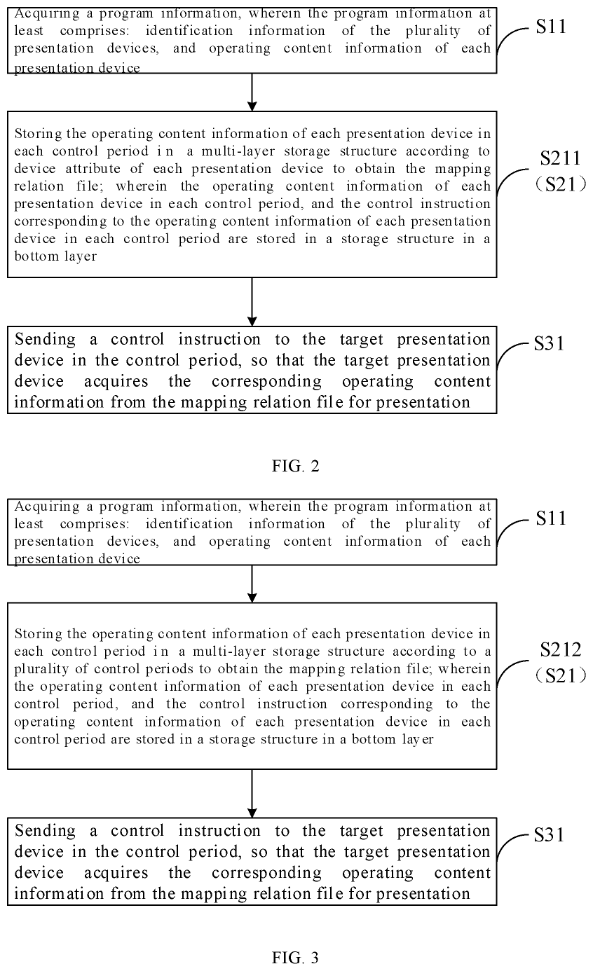

FIG. 2 is another schematic flowchart of a presentation control method according to an embodiment of the present disclosure. In some embodiments, as shown in FIG. 2, the step S21 may specifically include a step S211.

In step S211, the operating content information of each presentation device in each control period is stored in a multi-layer storage structure according to device attribute of each presentation device to obtain the mapping relation file; wherein the operating content information of each presentation device in each control period, and the control instruction corresponding to the operating content information of each presentation device in each control period are stored in a storage structure in a lowest layer (hierarchy).

In some embodiments, the number of storage structures in the lowest layer is multiple, and each storage structure corresponds to one presentation device; for each storage structure, the content stored in the storage structure is associated with a corresponding presentation device, and specifically includes: the operating content information of the presentation device corresponding to the storage structure in each control period and the control instruction corresponding to the operating content information.

Specifically, the program information includes a plurality of presentation programs, and each presentation program is necessarily presented by a plurality of presentation devices in cooperation with each other. Based on this, in the embodiment of the present disclosure, the mapping relation file having the multi-layer storage structure (i.e., the hierarchical storage structure) is established according to the device attribute of each presentation device, so that it is convenient to allocate the operating content information of each presentation device in each period for each presentation device. The device attribute may include a device type and the identification information.

Information stored in a storage structure in a top layer in the mapping relation file includes the operating content information of each presentation device in each control period, and the control instruction of each presentation device corresponding to each control period. The storage structure in the top layer is not described in the following examples.

In one example, firstly, in a storage structure in a second layer, a plurality of presentation devices may be divided according to their corresponding device types. That is, the second layer includes a storage structure A, a storage structure B, and a storage structure C, where the storage structure A stores therein: A information corresponding to a plurality of display devices; the storage structure B stores therein: B information corresponding to a plurality of audio devices; the storage structure C stores therein: C information corresponding to a plurality of lighting devices. The A information includes operating content information of each display device corresponding to each control period and a control instruction of each display device corresponding to each control period, the B information includes operating content information of each audio device corresponding to each control period and a control instruction of each audio device corresponding to each control period, and the C information includes operating content information of each lighting device corresponding to at least one control period and a control instruction of each lighting device corresponding to each control period.

Secondly, in a third layer, a plurality of presentation devices may be divided according to their corresponding identification information. By taking the display device as an example, storage structures A1, A2 and A3 in the third layer are all linked with the storage structure A, where the storage structure A1 stores therein: A1 information corresponding to a display device identified by A1, the storage structure A2 stores therein: A2 information corresponding to a display device identified by A2; the storage structure A3 stores therein: A3 information corresponding to a display device identified by A3, and the like. The A1 information includes operating content information of a plurality of A1-identified display devices corresponding ton each control period, and a control instruction of the A1-identified display devices corresponding to each control period; the A2 information includes operating content information of a plurality of A2-identified display devices corresponding to each control period, and a control instruction of the A2-identified display devices corresponding to each control period; the A3 information includes operating content information of a plurality of A3-identified display devices corresponding to each control period, and a control instruction of the A3-identified display device corresponding to each control period.

It will be appreciated that each control instruction has a corresponding frequency, and the frequencies of control instructions corresponding to different control periods are different for the same presentation device; likewise, the frequencies of control instructions corresponding to different presentation devices are different in the same control period.

The device attribute of the presentation device may include other feature information in addition to the type and the identifier of the display device, and correspondingly, the mapping relation file may include the storage structures with more layers divided according to the other device attributes, which is not limited in the embodiment of the present disclosure.

FIG. 3 is another schematic flowchart of a presentation control method according to an embodiment of the present disclosure. In some embodiments, as shown in FIG. 3, the step S21 may specifically include a step S212.

In step S212, the operating content information of each presentation device in each control period is stored by adopting a multi-layer storage structure according to a plurality of control periods to obtain the mapping relation file; wherein the operating content information of each presentation device in each control period, and the control instruction corresponding to the operating content information of each presentation device in each control period are stored in a storage structure in a lowest layer.

The number of storage structures in the lowest layer is multiple, and each storage structure corresponds to one control period. For each storage structure, the storage structure stores therein: the operating content information of respective presentation devices operating in the corresponding control period, and the control instructions corresponding to the operating content information.

In one example, each control period has a duration to, and the presentation period of each presentation covers one or more control periods. For example, each storage structure in the second layer corresponds to one presentation program. By taking a storage structure M2 as an example, the storage structure M2 corresponds to a presentation program M2, and a presentation period of the presentation program M2 covers M control periods (M is an integer greater than 1), and the storage structure M2 stores therein: the operating content information of each presentation device participating in the presentation program M2 in each of the M control periods, and the control instruction corresponding to the operating content information. For example, the storage structure M2 is linked with storage structures M31, M32, M33 in the third layer, the storage structure M31 corresponds to one segment M21 in the presentation program M2, the storage structure M32 corresponds to one segment M22 in the presentation program M2, and the storage structure M33 corresponds to one segment M23 in the presentation program M2. Taking the storage structure M31 and its corresponding segment M21 as an example, assuming that the presentation period of the segment M21 covers q control periods (q is an integer greater than 1), the storage structure M31 stores therein: the operating content information of each presentation device participating in the segment M21 in each of the q control periods, and the control instruction corresponding to the operating content information. For example, the storage structure M31 is linked with storage structures M41, M42 . . . M4q in the fourth layer, and each of the storage structures M41, M42 . . . M4q corresponds to one control period, and each of the storage structures M41, M42 . . . M4q stores therein: the pieces of operating content information of the presentation devices operating in the corresponding control period, and the control instructions corresponding to the pieces of operating content information.

It should be noted that during the stage performance, especially the opening ceremony or the closing ceremony of a large sports event, some ceremonies need to be performed precisely at a certain time, and therefore, the time during the presentation process is required to be precise to the second or even millisecond level. Based on this, in some embodiments, the control period is less than 1 second.

Specifically, in the storage structure in the lowest layer, the data granularity of the control information stored in the storage structure can be reduced to a unit in a second or even millisecond level, and the corresponding control period is also reduced to a range smaller than 1 second, so that the problems of the delay of the presentation device, the data sticky phenomenon in the information transmission process, the data redundancy and the like are avoided, and the program/stage presentation effect is accurately controlled to a millisecond level.

In some embodiments, each of the remaining layers, except for the top layer, includes a plurality of storage structures. In any two adjacent layers, there is a link between one storage structure in a previous layer and a plurality of storage structures in a next layer (i.e., the layer below the previous layer). For example, one storage structure in the previous layer is linked to the plurality of storage structures in the next layer by pointers or indexes.

Specifically, after the target presentation device receives the control instruction, the control information is acquired according to the identification information of the target presentation device, that is, the operating content information in the control period corresponding to the control instruction is searched according to the identification information, and in the process that the target presentation device searches for the corresponding information in the mapping relation file, the search starts from the program information in the storage structure in the top layer, searches layer-by-layer, until the storage structure in in the lowest layer. Therefore, in the adjacent layers, there is a link between one storage structure in the previous layer and the plurality of storage structures in the next layer, so that the target presentation device can acquire the corresponding operating content information.

Based on the link relation between the storage structures of the hierarchical storage structure, the data granularity of the program information is gradually reduced, the control precision of the program information is improved. The plurality of presentation devices are controlled according to the corresponding control instruction stored in the storage structure in the lowest layer, so that the communication delay and the data sticky phenomenon are avoided, the presentation operations of all the presentation devices in the corresponding control period are ensured to be completed, and the program presentation effect is improved.

It should be understood that each presentation device may be intermittently operated during the entire stage program, and thus, there is no corresponding operating content information in the periods in which the presentation device is not operated, and thus no control instruction is required. In one example, a presentation device m performs presentations in periods from 1 ms to 5 ms, 12 ms to 15 ms, and 20 ms to 35 ms, respectively, and thus has the above three control periods and receives a control instruction transmitted by the control device in each control period.

In some embodiments, “the control instruction is sent to the target presentation device in the control period” in the step S31, which may specifically include: sending the control instruction, by the control device, to all the presentation devices at the initial time of the control period, so that each presentation device verifies the control instruction, and after the verification is passed, the presentation device is determined to be the target presentation device.

Specifically, each presentation device has corresponding identification information, so after the presentation device receives the control instruction, verification is performed on the presentation device according to the identification information of the presentation device and the identification information carried in the control instruction. If the identification information of the presentation device and the identification information carried in the control instruction are the same, the verification is passed.

In some embodiments, the identification information may include a MAC address of the presentation device. In addition, in addition to the MAC address, other device information capable of identifying the plurality of presentation devices may also be used as the identification information, which is not limited in the embodiment of the present disclosure.

In some embodiments, the device types of the plurality of presentation devices include: at least two of the display device, the audio device and the lighting device, and the various types of presentation devices jointly execute the pre-programmed content in the program information, thereby completing the presentation program.

The presentation control method provided in the above embodiment of the present disclosure is applied to the control device in the presentation system. The control instruction carrying the identification information of the target presentation device is sent to the presentation device in the control period, where the control instruction has a corresponding frequency corresponding to the operating content information of the presentation device in the control period; and after the verification is performed on the presentation device according to the identification information and the verification is passed, the corresponding operating content information is acquired from the mapping relation file for presentation. The process of performing, by the presentation device, the device verification on the presentation device and acquiring the operating content information will be described below in detail.

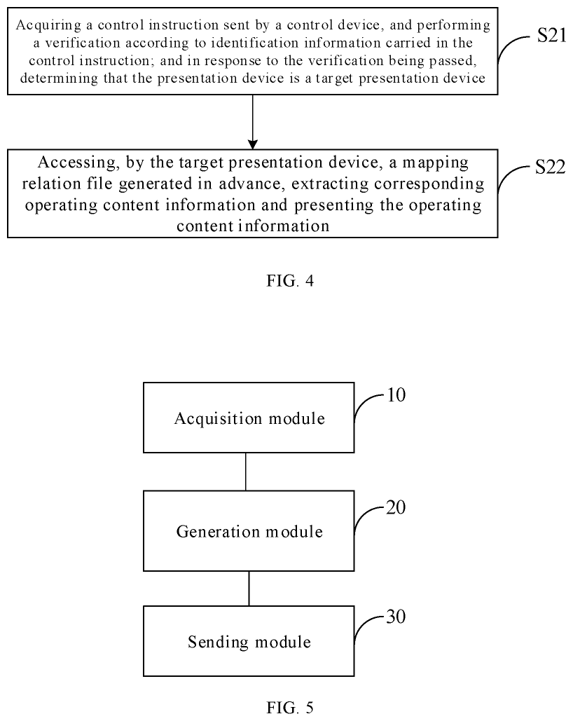

FIG. 4 shows another presentation control method provided in an embodiment of the present disclosure, which is applied to the presentation device in the presentation system. As shown in FIG. 4, the method includes steps S21 and S22.

In step S21, the control instruction sent by the control device is acquired, and the verification is performed according to the identification information carried in the control instruction; and in the case that the verification is passed, it is determined that the presentation device is the target presentation device.

Specifically, the step S21 may include: when the identification information of the presentation device is consistent with the identification information carried in the control instruction, the verification is passed.

In step S22, the target presentation device accesses the mapping relation file generated in advance, extracts the corresponding operating content information and operates according to the operating content information.

According to the presentation control method provided by the embodiment of the present disclosure, each presentation device has corresponding identification information, so that after the presentation device receives the control instruction, the verification is performed according to the identification information of the presentation device and the identification information carried in the control instruction, and if the identification information of the presentation device and the identification information carried in the control instruction are the same, the verification is passed. The method avoids the problem that the operating content information is not matched with the presentation device, realizes the accurate control of each presentation device and each presentation program in the large-scale stage performance, and improves the program presentation effect.

In other embodiments, the mapping relation file includes a multi-layer storage structure; in the lowest layer, the number of the storage structures is multiple, each storage structure corresponds to one presentation device, and each storage structure stores therein: the operating content information of the presentation device in respective control periods and the corresponding control instructions.

In this case, the step S22 may include: determining, by the target presentation device, a target storage structure in the multiple storage structures according to the identification information; and extracting, by the target presentation device, the operating content information corresponding to the frequency from the target storage structure according to the frequency of the control instruction.

Specifically, the control instruction, the occupied frequency, the control period, the control information and the presentation device are all correlated with each other. That is, in the control period, the control device sends the control instruction which occupies a certain frequency and carries identification information to the presentation device, and the presentation device performs the verification according to the identification information and if the verification is passed, the presentation device extracts the corresponding operating content information in the mapping relation file according to the frequency.

It should be noted that the control information corresponding to the control instruction includes a plurality of pieces of operating content information of the target presentation device corresponding to a plurality of control periods, but when the target presentation device extracts the information from the target storage structure, only the operating content information corresponding to the current control period is extracted. That is, the target storage structure stores therein the control information corresponding to the target presentation device. Each control period corresponds to the control instruction with the corresponding frequency, so that the target presentation device may identify and extract, according to the frequency, the operating content information in the current control period from the control information.

In other embodiments, the mapping relation file includes a multi-layer storage structure; the number of the storage structures in the lowest layer is multiple, each storage structure corresponds to one control period, and each storage structure stores therein: the operating content information of respective presentation devices operating in the control period and the corresponding control instructions.

In this case, the step S22 may include: determining, by the target presentation device, a target storage structure of the multiple of storage structures according to the control period; and extracting, by the target presentation device, the operating content information corresponding to the frequency and the identification information from the target storage structure according to the frequency of the control instruction and the identification information.

Specifically, in the above embodiment, the multi-layer storage structure included in the mapping relation file may be divided according to the device attribute of the presentation device, and each storage structure in the lowest layer corresponds to one presentation device, and stores therein the operating content information of the presentation device in the control periods and the corresponding control instructions. The present embodiment is different from the previous embodiment in that each storage structure in the lowest layer corresponds to one control period, and the multiple presentation devices perform presentation in each control period, so that each storage structure in the lowest layer stores therein the operating content information of the multiple presentation devices operating in the control period and the corresponding control instructions.

Accordingly, after the target presentation device determines the corresponding target storage structure, it is necessary to determine the operating content information according to the two pieces of information, which are the frequency and the identification information. The identification information is used to determine the target presentation device among “the plurality of presentation devices operating in the control period”, and the frequency is used to determine the operating content information of the current control period required by the target presentation device.

In addition, communication is established between the presentation device and the mapping relation file through a WebSocket communication protocol (a WS protocol), and the WS protocol is characterized in that bidirectional communication may be established between two communication devices only through one-time handshaking action to form a data transmission channel. Based on the protocol, the communication efficiency between the presentation device and the mapping relation file is improved, and the poor presentation effect caused by the data delay is avoided.

FIG. 5 is a schematic diagram of a structure of a control device according to an embodiment of the present disclosure, where the control device is configured to execute the presentation control method described in FIG. 1 to FIG. 3.

As shown in FIG. 5, the control device includes: an acquisition module 10, a generation module 20 and a sending module 30.

The acquisition module 10 is configured to acquire program information, and the program information at least includes: identification information of a plurality of presentation devices, operating content information of each presentation device.

The generation module 20 is configured to generate a mapping relation file according to the program information; where the mapping relation file includes a plurality of control instructions with frequencies and control information corresponding to each control instruction, and each control instruction corresponds to one control period; each control instruction at least carries identification information of a target presentation device, and the control information at least includes operating content information of the target presentation device in a control period; the target presentation device is a presentation device operating in the control period.

The sending module 30 is configured to send a control instruction to the target presentation device in the control period, so that the target presentation device acquires the corresponding operating content information from the mapping relation file for presentation.

The functions of the modules refer to the descriptions in the presentation control method described in FIG. 1 to FIG. 3, and are not described again here.

FIG. 6 is a schematic diagram of a structure of a presentation device according to an embodiment of the present disclosure, where the presentation device is configured to execute the presentation control method described in FIG. 4.

As shown in FIG. 6, the control device includes: a verification module 40 and an extraction module 50.

The verification module 40 is configured to acquire the control instruction sent by the control device, and perform the verification according to the identification information carried in the control instruction; and determine that the presentation device is the target presentation device in the case that the verification is passed.

The extraction module 50 is configured to access, by the target presentation device, the mapping relation file generated in advance, extract the corresponding operating content information for presentation.

The functions of the modules refer to the description in the presentation control method described in FIG. 4, and are not described again here.

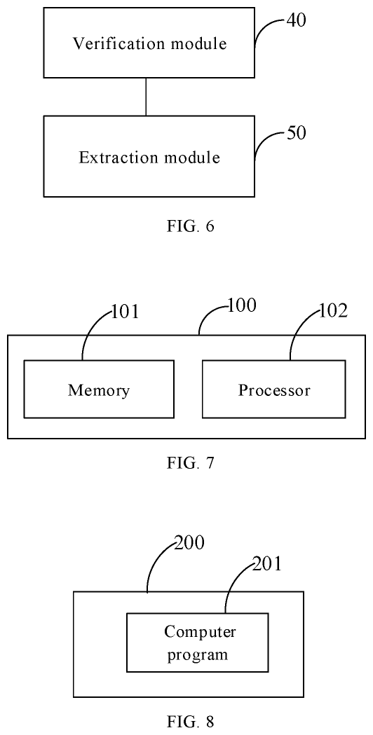

FIG. 7 is a schematic diagram of another structure of a control device according to an embodiment of the present disclosure. As shown in FIG. 7, the control device 100 includes: a memory 101 and a processor 102, the memory 101 having stored thereon a computer program, wherein the computer program, when executed by the processor 102, implements the above presentation control method, for example steps S11 to S31 in FIG. 1, and/or steps S21 to S22 in FIG. 4.

The control device 100 may be a computing device such as a desktop computer, a notebook, a palm computer, or a cloud server, or the like. The control device 100 may include, but is not limited to, the processor 102 and the memory 101. It will be understood by a person skilled in the art that FIG. 7 is merely an example of the control device 100, and does not constitute a limitation of the control device 100, and the control device 100 may include more or less components than those shown, or combine some or different components. For example, the control device 100 may further include an input output device, a network access device, a bus, and the like.

The processor 102 may be a central processing unit (CPU), other general purpose processor, a digital signal processor (DSP), an application specific integrated circuit (ASIC), a field-programmable gate array (FPGA) or other programmable logic device, discrete gate or transistor logic, discrete hardware components, or the like. The general purpose processor 102 may be a microprocessor or any conventional processor or the like.

The memory 101 may be an internal storage unit of the control device 100, such as a hard disk or a memory of the control device 100. The memory 101 may also be an external storage device of the control device 100, such as a plug-in hard disk, a smart media card (SMC), a secure digital (SD) card, or a flash card, or the like, provided on the control device 100. Further, the memory 101 may also include both the internal storage unit and the external storage device of the control device 100. The memory 101 is used for storing the computer programs and other programs and data required by the terminal device. The memory 101 may also be used to temporarily store data that has been output or is to be output.

It should be clear to a person skilled in the art that for convenience and simplicity of description, the division of the functional units and modules is only used for illustration, and in practical applications, the above function distribution may be performed by different functional units and modules as needed, that is, the internal structure of the device may be divided into different functional units or modules to perform all or part of the functions. The functional units and modules in the embodiments may be integrated in one processing unit, or the units may exist alone physically, or two or more units are integrated in one unit, and the integrated units may be implemented in a form of hardware, or in a form of a software functional unit. In addition, specific names of the functional units and modules are only used for distinguishing one functional unit from another, and are not used for limiting the protection scope of the present application. For the specific operating processes of the units and modules in the system, reference may be made to the corresponding processes in the foregoing method embodiments, which are not described herein again.

FIG. 8 is a schematic diagram of a computer-readable storage medium provided in some embodiments of the present disclosure. As shown in FIG. 8, a computer program 201 is stored on the computer-readable storage medium 200, where the computer program 201 when being executed by a processor to implement the presentation control method, for example, implement steps S11 to S31 in FIG. 1 and/or steps S21 to S22 in FIG. 4. The computer-readable storage medium 200 includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and may be accessed by a computer. In addition, the communication medium typically embodies computer readable instructions, data structures, program modules or other data in a modulated data signal such as a carrier wave or other transport mechanism and includes any information delivery medium as is well known to a person skilled in the art.

It should be understood that the above embodiments are merely exemplary embodiments adopted to explain the principles of the present disclosure, and the present disclosure is not limited thereto. It will be apparent to one of ordinary skill in the art that various changes and modifications may be made therein without departing from the spirit and scope of the present disclosure, and such changes and modifications also fall within the scope of the present disclosure.

1. A presentation control method applied to a control device in a presentation system, the presentation system further comprising a plurality of presentation devices, wherein the method comprises:
acquiring a program information, wherein the program information at least comprises: identification information of the plurality of presentation devices, and operating content information of each presentation device;
generating a mapping relation file according to the program information; wherein the mapping relation file comprises a plurality of control instructions with frequencies and control information corresponding to each control instruction, and each control instruction corresponds to one control period; each control instruction at least carries identification information of a target presentation device, and the control information at least comprises operating content information of the target presentation device in a control period; and the target presentation device is a presentation device operating in the control period; and
sending a control instruction to the target presentation device in the control period, so that the target presentation device acquires the corresponding operating content information from the mapping relation file for presentation.

2. The presentation control method of claim 1, wherein generating the mapping relation file according to the program information comprises:
storing the operating content information of each presentation device in each control period in a multi-layer storage structure according to device attribute of each presentation device to obtain the mapping relation file; wherein the operating content information of each presentation device in each control period, and the control instruction corresponding to the operating content information of each presentation device in each control period are stored in a storage structure in a lowest layer of the multi-layer storage structure.

3. The presentation control method of claim 2, wherein each of the remaining layers of the multi-layer storage structure, except for a top layer, comprises a plurality of storage structures, and in any two adjacent layers, one storage structure in a previous layer is linked to a plurality of storage structures in a next layer.

4. The presentation control method of claim 2, wherein a lowest layer of the multi-layer storage structure has multiple storage structures, each of the multiple storage structures corresponds to one presentation device, and stores therein: the operating content information of the presentation device in respective control periods and the corresponding control instructions.

5. The presentation control method of claim 1, wherein generating the mapping relation file according to the program information comprises:
storing the operating content information of each presentation device in each control period in a multi-layer storage structure according to a plurality of control periods to obtain the mapping relation file; wherein the operating content information of each presentation device in each control period, and the control instruction corresponding to the operating content information of each presentation device in each control period are stored in a storage structure in a lowest layer of the multi-layer storage structure.

6. The presentation control method of claim 5, wherein each of the remaining layers of the multi-layer storage structure, except for a top layer, comprises a plurality of storage structures, and in any two adjacent layers, one storage structure in a previous layer is linked to a plurality of storage structures in a next layer.

7. The presentation control method of claim 5, wherein a lowest layer of the multi-layer storage structure has multiple storage structures, each of the multiple storage structures corresponds to one control period and stores therein: the operating content information of respective presentation devices operating in the control period and the corresponding control instructions.

8. The presentation control method of claim 1, wherein sending the control instruction to the target presentation device in the control period comprises:
sending the control instruction to all the presentation devices at an initial time of the control period, so that each of the presentation devices verifies the control instruction, and determines the presentation device is the target presentation device after the verification is passed.

9. The presentation control method of claim 1, wherein the identification information comprises a MAC address of the presentation device.

10. The presentation control method of claim 1, wherein device types of the plurality of presentation devices comprise: at least two of a display device, an audio device, a lighting device.

11. The presentation control method of claim 1, wherein the control period is less than 1 second.

12. A presentation control method applied to a presentation device in a presentation system, the method comprising:
acquiring a control instruction sent by a control device, and performing a verification according to identification information carried in the control instruction; and in response to the verification being passed, determining that the presentation device is a target presentation device; and
accessing, by the target presentation device, a mapping relation file generated in advance, extracting corresponding operating content information and operating according to the operating content information.

13. The presentation control method of claim 12, wherein
acquiring the control instruction sent by the control device, and performing the verification according to the identification information carried in the control instruction comprises:
the verification is passed in response to the identification information of the presentation device being consistent with the identification information carried in the control instruction.

14. The presentation control method of claim 12, wherein the mapping relation file comprises a multi-layer storage structure; a lowest layer of the multi-layer storage structure comprises multiple storage structures, each of the multiple storage structures corresponds to one presentation device, and each of the multiple storage structures stores therein: the operating content information of the presentation device in respective control periods and the corresponding control instructions;
the accessing, by the target presentation device, the mapping relation file generated in advance, extracting the corresponding operating content information comprises:
determining, by the target presentation device, a target storage structure in the multiple of storage structures according to the identification information; and
extracting, by the target presentation device, the operating content information corresponding to the frequency from the target storage structure according to the frequency of the control instruction.

15. The presentation control method of claim 12, wherein the mapping relation file comprises a multi-layer storage structure; a lowest layer of the multi-layer storage structure comprises multiple storage structures, each of the multiple storage structures corresponds to one control period, and each of the multiple storage structures stores therein: the operating content information of respective presentation devices operating in the control period and the corresponding control instructions;
the accessing, by the target presentation device, the mapping relation file generated in advance, extracting the corresponding operating content information comprises:
determining, by the target presentation device, a target storage structure of the multiple storage structures according to the control period; and
extracting, by the target presentation device, the operating content information corresponding to the frequency and the identification information from the target storage structure according to the frequency of the control instruction and the identification information.

16. A control device, comprising:
an acquisition module configured to acquire a program information, wherein the program information at least comprises: identification information of the plurality of presentation devices, and operating content information of each presentation device;
a generation module configured to generate a mapping relation file according to the program information; wherein the mapping relation file comprises a plurality of control instructions with frequencies and control information corresponding to each control instruction, and each control instruction corresponds to one control period; each control instruction at least carries identification information of a target presentation device, and the control information at least comprises operating content information of the target presentation device in a control period; and the target presentation device is a presentation device operating in the control period; and
a sending module configured to send a control instruction to the target presentation device in the control period, so that the target presentation device acquires the corresponding operating content information from the mapping relation file for presentation.

17. (canceled)

18. A control device, comprising a memory and a processor, the memory having stored thereon a computer program, wherein the computer program, when executed by the processor, implements the method of claim 1.

19. A computer-readable storage medium, on which a computer program is stored, wherein the computer program, when executed by a processor, implements the method of claim 1.
